(19) United States
(12) Patent Application Publication
(10) Pub. No.: US 2020/0049930 A1
(43) Pub. Date: Feb. 13, 2020

(54) LENS MODULE

(71) Applicant: AAC Technologies Pte. Ltd., Singapore city (SG)

(72) Inventor: Chuandong Wei, Shenzhen (CN)

(21) Appl. No.: 16/528,670

(22) Filed: Aug. 1, 2019

(30) Foreign Application Priority Data
Aug. 7, 2018 (CN) 201821271942.3

(51) Int. Cl. G02B 7/02

(52) U.S. Cl. CPC G02B 7/025; G02B 7/022

(57) ABSTRACT

The present disclosure relates to the optical lenses, and provides a lens module. The lens module includes a lens barrel, a first lens arranged at an object side of the lens barrel, and a fixing part for pressing the first lens against the lens barrel from an object side of the first lens. The fixing part includes a top wall for pressing the first lens, and a side wall extending from the top wall while being bent towards an image side and fixedly connected to the lens barrel. The top wall is in contact with the first lens, and a glue is filled between the side wall and the first lens, and bonds and fixes the first lens to the side wall. The lens module provided by the present disclosure has a higher reliability and sealing property.

### TECHNICAL FIELD

The present disclosure relates to the technical field of optical lenses, and in particular, to a lens module.

### BACKGROUND

With development of technologies, various devices are equipped with a lens module. For example, with respect to safety hazard during driving a vehicle, the vehicle is equipped with a vehicle-mounted lens module. In the related art, the vehicle-mounted lens usually includes a lens barrel and a plurality of lenses received in the lens barrel.

The inventors have found a problem existing in the prior art: the vehicle-mounted lenses are subjected to external forces caused by, for example, vibration, friction, and collision during the use of the vehicle-mounted lens module, such that the vehicle-mounted lens module has a poor stability and is unsuitable for bad operating environment. Moreover, the vehicle-mounted lens module has such a poor sealing performance that external debris can easily enter the lens barrel and affect the optical performance of the lens. Therefore, it is urgent to provide a new lens module to solve the above problem.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a structural schematic cross-sectional view of a lens module according to an embodiment of the present disclosure; and

FIG. 2 is a schematic cross-sectional view of an assembled structure of a first lens and a fixing part according to an embodiment of the present disclosure.

### DESCRIPTION OF EMBODIMENTS

The present disclosure will be further illustrated with reference to the accompanying drawings and the embodiments.

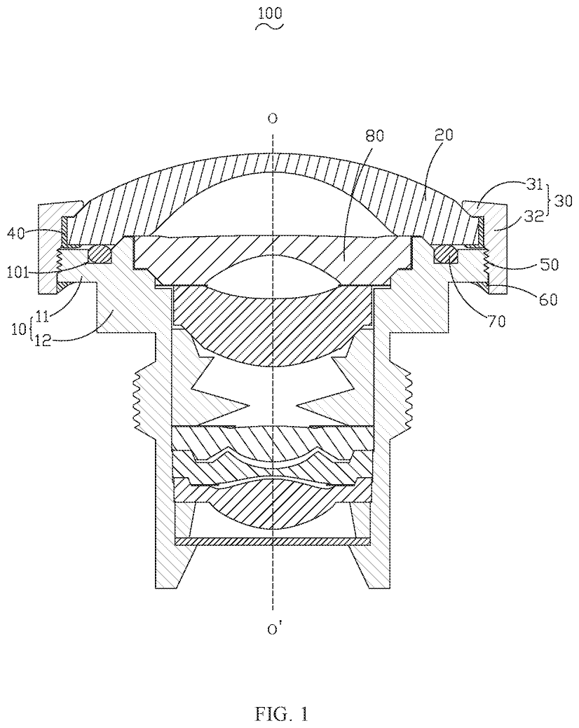

An embodiment of the present disclosure provides a lens module 100. As shown in FIG. 1, the lens module 100 includes a lens barrel 10, a first lens 20 arranged at an object side of the lens barrel 10, and a fixing part 30 for pressing the first lens 20 against the lens barrel 10 from an object side of the first lens 20. The fixing part 30 includes a top wall 31 for pressing the first lens 20, and a side wall 32 extending from the top wall 31 while being bent towards an image side and fixedly connected to the lens barrel 10. The top wall 31 is in contact with the first lens 20. A glue 40 is filled between the side wall 32 and the first lens 20, and the glue 40 bonds and fixes the first lens 20 to the side wall 32.

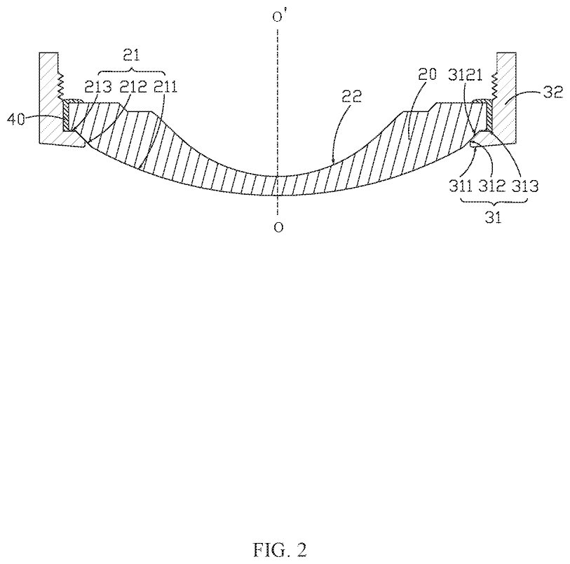

Compared with the related art, in this embodiment of the present disclosure, the fixing part 30 presses the first lens 20 against the lens barrel 10, and the top wall 31 of the fixing part 30 is in contact with the first lens 20, so as to fix the lens 20 to the lens barrel 10. The glue 40 is filled between the side wall 32 of the fixing part 30 and the first lens 20, so as to bond and fix the first lens 20 to the side wall 32, thereby increasing the stability of the fixation between the fixing part 30 and the first lens 20 and improving reliability of lens module 100. The glue 40 can also prevent external debris from entering the lens module 100 via a position where the fixing part 30 abuts against the first lens 20, thereby improving a sealing performance of the lens module 100. With reference to FIG. 2, during the assembling, the first lens 20 is mounted into the fixing part 30 until the first lens 20 abuts against the top wall 31, then the glue 40 is filled between the first lens 20 and the side wall 32 and the glue 40 is pre-solidified, so as to bond the fixing part 30, to which the first lens 20 is fixed, to the lens barrel 10.

Specifically, the lens barrel 10 includes a first barrel wall 11 close to the object side and abutting against the first lens, and a second barrel wall 12 extending from the first barrel wall 11 while being bent towards the image side. The first barrel wall 11, cooperating with the fixing part 30, is configured to fix the first lens 20, and the second barrel wall 12 is configured to support and fix other optical elements in the lens module 100.

The first lens 20 includes an incident surface 21 close to the object side, and an emergent surface 22 close to the image side. The incident surface 21 includes an incident portion 211 located at a central position, a matching portion 212 surrounding the incident portion 211, and a supporting portion 213 surrounding the matching portion 212.

The fixing part 30 includes a top wall 31 and a side wall 32. The top wall 31 includes an object side surface 311, an image side surface 313 opposite to object side surface 311, and a connecting surface 312 connecting the object side surface 311 with the image side surface 313. The connecting surface 312 includes an oblique surface 3121 connected to the image side surface 313 and oblique with respect to an optical axis OO′ of the lens module 100. The oblique surface 3121 is in contact with the first lens 20.

Specifically, the oblique surface 3121 is attached to the matching portion 212, and the supporting portion 213 directly face the image side surface 313. The oblique surface 3121 matches the matching portion 212. The first lens 20 slides into the fixing part 30 during the assembling, until the matching portion 212 of the first lens 20 is attached to the oblique surface 3121 of the fixing part 30. In this way, it is unnecessary to adjust a relative position between the first lens 20 and the fixing part 30, thereby simplifying the assembling process and guaranteeing an accurate positioning and stable fixation between the first lens 20 and the fixing part 30. Therefore, the reliability of the lens module 100 is improved.

Preferably, the image side surface 313 is spaced apart from the supporting portion 213. More preferably, the image side surface 313 is parallel to the supporting portion 213, and thus the friction between the image side surface 313 and the supporting portion 213 during the assembling, which may cause damaging of the first lens 20, can be avoided.

The glue 40 is filled between the first lens 20 and the side wall 32 and extends into the spacing between the image side surface 313 and the supporting portion 213, so as to ensure a more firm fixation between the first lens 20 and the fixing part 30, thereby further improving the reliability of lens module 100. More preferably, the glue 40 further extends to the emergent surface 22 and is spaced apart from the lens barrel 10, thereby further optimizing the sealing performance of the lens module 100.

It should be noted that, the lens module 100 is provided with threads 40 for fixedly connecting the first barrel wall 11 with the fixing part 30. In this embodiment, the fixing part 30 is a screw cap. During the assembling, the fixing part 30 is arranged at the object side of the lens barrel 10, and the first barrel wall 11 is screwed into the fixing part 30, so as to tightly connect the fixing part 30 to the lens barrel 10. In this way, it can prevent the first lens 20 located between the first barrel wall 11 and the fixing part 30 from departing from the lens barrel 10, and ensure a more stable fixing structure between the first lens 20, the fixing part 30 and the lens barrel 10, thereby further improving the reliability of the lens module 100.

Preferably, the lens module 100 is further provided with a thermosetting glue 60, and the first barrel wall 11 is fixedly connected to the fixing part 30 by means of the thermosetting glue 60. During the assembling, after the fixing part 30 is fixedly connected to the lens barrel 10, the thermosetting glue 60 is provided at the joint between the first barrel wall 11 and the fixing part 30, and then solidified. In this way, a possibility of the failure of the threads 50 can be reduced, thereby further improving the reliability of the lens module 100. Meanwhile, it can prevent external debris from entering the lens module 100 through the joint between the lens barrel 10 and the fixing part 30, thereby further optimizing the sealing performance of the lens module 100.

In this embodiment, the lens module 100 further includes a seal ring 70 arranged between the lens barrel 10 and the first lens 20, in order to ensure a tight connection between the first lens 20 and the lens barrel 10. More preferably, the lens barrel 10 is provided with a groove 101, and the seal ring 70 is received in the groove 101. In this way, an effective space in the lens module 100 that is occupied by the seal ring 60 can be reduced, thereby facilitating miniaturization of the lens module 100. In this embodiment, the groove 101 has an annular shape around the optical axis of the lens module.

It should be understood by those skilled in the art that the lens module 100 may further include at least one second lens 80 arranged in the lens barrel 10 at an image side of the first lens 20.

It should be understood by those skilled in the art that the above embodiments are merely some specific embodiments of the present disclosure, and various changes in form and details may be made without departing from the scope of the present disclosure.

What is claimed is:

1. A lens module, comprising:
a lens barrel;
a first lens arranged at an object side of the lens barrel; and
a fixing part for pressing the first lens against the lens barrel from an object side of the first lens,
wherein the fixing part comprises:
a top wall for pressing the first lens; and
a side wall extending from the top wall while being bent towards an image side, the
side well being fixedly connected to the lens barrel,
wherein the top wall is in contact with the first lens, and a glue is filled between the side wall and the first lens, and bonds and fixes the first lens to the side wall.

2. The lens module according to claim 1, wherein the top wall comprises an object side surface, an image side surface opposite to the object side surface, and a connecting surface connecting the object side surface with the image side surface,
the connecting surface comprises an oblique surface connected to the image side surface and oblique with respect to an optical axis of the lens module, and the oblique surface is in contact with the first lens.

3. The lens module according to claim 2, wherein the first lens comprises an incident surface close to the object side,
the incident surface comprises a incident portion located at a central location, a matching portion surrounding the incident portion and attached to the oblique surface, and a supporting portion surrounding the matching portion and directly facing the image side surface,
the image side surface is spaced apart from the supporting portion, and the glue extends into a spacing between the image side surface and the supporting portion.

4. The lens module according to claim 3, wherein the first lens further comprises an emergent surface close to the image side, and the glue extends to the emergent surface and is spaced apart from the lens barrel.

5. The lens module according to claim 1, wherein the lens barrel comprises a first barrel wall close to the object side and abutting against the first lens, and a second barrel wall extending from the first barrel wall while being bent towards the image side, the first barrel wall being fixedly connected to the fixing part by means of threads.

6. The lens module according to claim 5, wherein the first barrel wall is fixedly connected to the fixing part by means of a thermosetting glue.

7. The lens module according to claim 1, wherein a seal ring is provided between the lens barrel and the first lens.

8. The lens module according to claim 7, wherein the lens barrel is provided with a groove, and the seal ring is received in the groove.

9. The lens module according to claim 8, wherein the groove has an annular shape around an optical axis of the lens module.
